(19) United States
(12) Patent Application Publication
(10) Pub. No.: US 2026/0261760 A1
(43) Pub. Date: Sep. 3, 2026

(54) Preview One-Shot Autofocus for Backlit Scenes

(71) Applicant: Google LLC, Mountain View, CA (US)

(72) Inventors: Navinprashath Rameswari Rajagopal, Mountain View, CA (US); Leung Chun Chan, Sunnyvale, CA (US); Sung Hyun Hwang, Sunnyvale, CA (US); Hsuan Ming Liu, Taipei (TW); Gaurav Malik, Sunnyvale, CA (US); Ruben Manuel Velarde, Chula Vista, CA (US); Ying Chen Lou, Santa Clara, CA (US); Szepo Robert Hung, Austin, TX (US)

(21) Appl. No.: 19/491,204

(22) PCT Filed: Jun. 20, 2024
(86) PCT No.: PCT/US2024/034733

§ 371 Date: Dec. 8, 2025

Related U.S. Application Data
(60) Provisional application No. 63/522,022, filed on Jun. 20, 2023.

(51) Int. Cl. H04N 23/67; H04N 23/63; H04N 23/72; H04N 23/73; H04N 23/741; H04N 23/75

(52) U.S. Cl. CPC H04N 23/672; H04N 23/63; H04N 23/72; H04N 23/73; H04N 23/741; H04N 23/75

(57) ABSTRACT

A method includes executing a process of refining auto-exposure settings for an image sensor. The method also includes determining an autofocus confidence level based on at least one image captured by the image sensor while executing the process of refining the auto-exposure settings for the image sensor. The method further includes, based on the autofocus confidence level, interrupting the process of refining the auto-exposure settings to capture an image with greater exposure than the at least one image. The method additionally includes determining autofocus settings based on the image captured with greater exposure than the at least one image. The method further also includes configuring the image sensor based on the autofocus settings.

### CROSS-REFERENCE TO RELATED DISCLOSURE

This application claims priority to U.S. Provisional Patent Application No. 63/522,022, filed Jun. 20, 2023, which is incorporated herein by reference in its entirety.

### BACKGROUND

Many modern computing devices, including mobile phones, personal computers, and tablets, include image capturing devices. Some image capturing devices are configured with telephoto capabilities.

### SUMMARY

In an embodiment, a method includes determining an autofocus confidence level based on at least one image captured by an image sensor while executing a process of refining auto-exposure settings for the image sensor. The method additionally includes, based on the autofocus confidence level, interrupting the process of refining the auto-exposure settings to capture an image with greater exposure than the at least one image. The method further includes determining autofocus settings based on the image captured with greater exposure than the at least one image. The method also includes causing the image sensor to capture one or more additional images based on the autofocus settings.

In another embodiment, a computing system includes a control system. The control system is configured to determine an autofocus confidence level based on at least one image captured by an image sensor while executing a process of refining auto-exposure settings for the image sensor. The control system is further configured to, based on the autofocus confidence level, interrupt the process of refining the auto-exposure settings to capture an image with greater exposure than the at least one image. The control system is additionally configured to determine autofocus settings based on the image captured with greater exposure than the at least one image. The control system is also configured to cause the image sensor to capture one or more additional images based on the autofocus settings.

In a further embodiment, a non-transitory computer readable medium stores program instructions executable by one or more processors to cause the one or more processors to perform operations. The operations include determining an autofocus confidence level based on at least one image captured by an image sensor while executing a process of refining auto-exposure settings for the image sensor. The operations also include based on the autofocus confidence level, interrupting the process of refining the auto-exposure settings to capture an image with greater exposure than the at least one image. The operations further include determining autofocus settings based on the image captured with greater exposure than the at least one image. The operations additionally include causing the image sensor to capture one or more additional images based on the autofocus settings.

In another embodiment, a system is provided that includes means for determining an autofocus confidence level based on at least one image captured by an image sensor while executing a process of refining auto-exposure settings for the image sensor. The system further includes means for, based on the autofocus confidence level, interrupting the process of refining the auto-exposure settings to capture an image with greater exposure than the at least one image. The system additionally includes means for determining autofocus settings based on the image captured with greater exposure than the at least one image. The system also includes means for causing the image sensor to capture one or more additional images based on the autofocus settings.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE DRAWINGS

FIG. 1 illustrates an example computing device, in accordance with example embodiments.

FIG. 2 is a simplified block diagram showing some of the components of an example computing system.

FIG. 3 is a flow chart of a method, in accordance with example embodiments.

FIG. 4 depicts images, in accordance with example embodiments.

FIG. 5 depicts images with associated confidence values, in accordance with example embodiments.

FIG. 6 depicts capturing a sequence of images, in accordance with example embodiments.

FIG. 7 depicts an image captured for autofocus, in accordance with example embodiments.

FIG. 8 depicts an image captured with updated autofocus settings, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless indicated as such. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” within a described list of at least two terms is to indicate any of the listed terms or any combination of the listed terms.

The use of ordinal numbers such as “first,” “second,” “third” and so on is to distinguish respective elements rather than to denote a particular order of those elements. For the purpose of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment. In the figures, similar symbols typically identify similar components, unless context dictates otherwise. Further, unless otherwise noted, figures are not drawn to scale and are used for illustrative purposes only. Moreover, the figures are representational only and not all components are shown. For example, additional structural or restraining components might not be shown.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Overview

An image capturing device may be included in a computing system (e.g., a smartphone, laptop, among other examples). Additionally and/or alternatively, the image capturing device may be a remote image capturing device, which may communicate with a computing system (e.g., a smartphone, laptop, server device, among other examples). Regardless of whether the image capturing device is integrated within the computing system or remote from the computing system, the computing system may display a preview of an image that could be captured by the image capturing device. For instance, if a park is included in the field of view of the image capturing device, the image capturing device may send a preview including the park to the computing system, and the computing system may display the preview including the park as included in the field of view of the image capturing device.

An issue that may arise in this process is capturing or showing a preview of an image that is properly focused. In particular, capturing or showing a scene with a high dynamic range (a large brightness range between the darkest and lightest parts of the scene) with proper focus may be particularly difficult, as scenes with high dynamic ranges may include regions that are very bright as well as regions that are particularly dark. For instance, if the user takes a picture of a tree facing a setting sun, the image preview and/or image may capture the details of the sky, with a tree in front of the sky being fairly dark and undetailed. Another image or image preview of the same scene may have higher exposure and depict the tree in detail, but may depict the sky as very bright and undetailed. In some examples, details may be recovered from underexposed areas of an image, whereas details from overexposed areas of an image may be unable to be recovered. Therefore, a computing system may intentionally underexpose an image or an image preview so that details may be recovered from dark portions of an image, perhaps during post processing. However, due to the high dynamic range of such an image and the portions of the image that are largely underexposed, the computing system may be unable to accurately determine where in the image to focus.

Described herein are techniques for an image capturing device to autofocus using a one-shot autofocus process that schedules special frames having an appropriate exposure to determine autofocus. The computing system may determine autofocus settings from scheduling a single frame with appropriate exposure in a stream of images used to determine auto-exposure and maximize dynamic range. The computing system may drop the special frames from the preview and/or the special frames may be excluded from images being displayed by the computing system. The computing system may also schedule the special frames to be captured at a lower frequency than the images for determining auto-exposure settings and/or maximizing dynamic range.

As mentioned above, in seeking to maximize dynamic range, the computing system may continuously adjust auto-exposure settings from each captured image and/or each image preview. In some examples, individual captured images may be combined using high dynamic range (HDR) imaging techniques to increase the dynamic range of images of scenes captured as photos or video. By capturing multiple images of the same scene with different exposures and combining the multiple images, a combined image may be generated with a higher dynamic range than the dynamic range of each individual captured image. With each image, the computing system may evaluate the image for an autofocus confidence level or otherwise determine whether accurate autofocus settings may be determined from the image. If the computing system determines that the autofocus confidence level is not above a threshold confidence level or otherwise determines that accurate autofocus settings cannot be determined from the image, the computing system may interrupt the process of refining the auto-exposure settings to capture an image with greater exposure than the image.

In particular, the computing system could schedule capture of an image with greater exposure at a particular time in the future, such that capture of the image does not interrupt image capturing and/or image previewing. Because the captured image may have greater exposure, areas of the image may be overexposed and/or washed out, perhaps such that the computing system may not be able to display details of those areas. The computing system may thus only display the images captured when adjusting for auto-exposure and the computing system may drop the images captured for determining autofocus.

To facilitate determining autofocus using images with greater exposure, the computing system may schedule capture of an image for autofocus with greater exposure. Scheduling capture of an image for autofocus may help ensure that image capturing and/or image previews are not disrupted by the capture of an image with greater exposure. In particular, the computing system may schedule capture of the image in advance, perhaps based on a frame rate at which the preview operates, a frame rate at which the sensor captures images, and/or exposure time for the images used for auto-exposure and/or the exposure time for the image used for autofocus.

For instance, the computing system may display a preview of a scene at a frame rate of 30 frames per second. To determine a stream of images to be used for the preview, the computing system may capture a stream of images for display such that each image has an exposure time of 1/2000 seconds, and the computing system may determine that an image for autofocus may be captured with an exposure time of 1/1000 seconds. Due to the frame rate at which the computing system displays a preview of the scene and the exposure time, the computing system may capture an image for autofocus between two images captured for display, and the computing system may drop the image captured for autofocus without any delay in the display.

In some examples, the computing system may extend display of one or more images in the stream of images for display to compensate for the time the computing system takes to capture an image for autofocus. For instance, the computing system may display a preview of a scene at a frame rate of 30 frames per second. The computing system may capture a stream of images for display such that each image has an exposure time of 1/30 seconds, and after the capture of each of these images, the computing system may adjust the auto-exposure settings. Upon determination that an image of the stream of images with a signal to noise ratio below a threshold amount or that the image is otherwise insufficient to determine autofocus, the computing system may schedule capture of an image for autofocus. The computing system may determine that the image may be captured with an exposure time of 1/15 seconds, and the computing system may send a request to the auto-exposure process to schedule capture of an image for autofocus. Because the frame rate is 30 frames per second and the exposure time for the stream of images is 1/30 seconds, the computing system may extend display of an image captured for auto-exposure by two frames while the computing system captures the image with an exposure time of 1/15 seconds.

### II. Example Systems and Methods

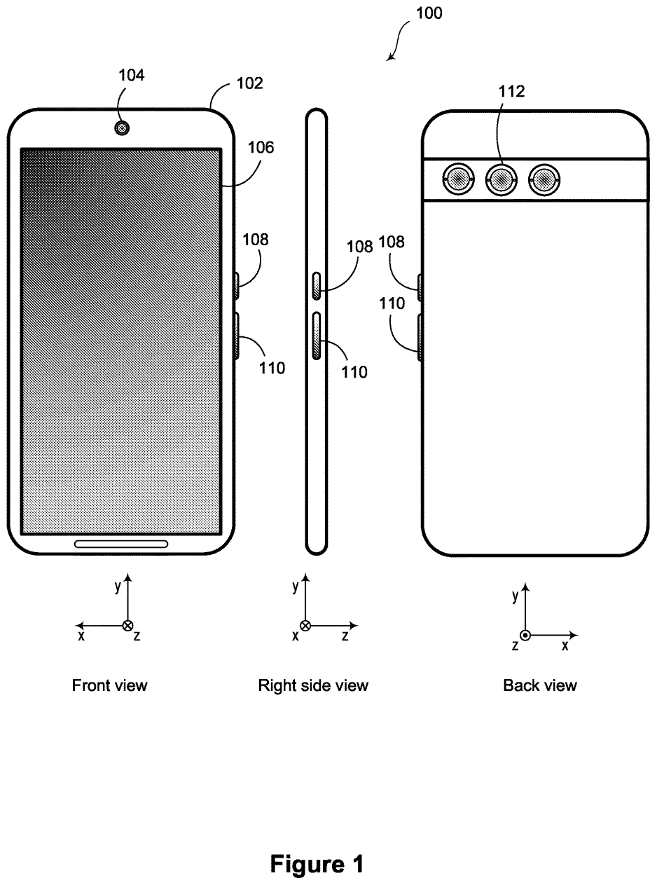

FIG. 1 illustrates an example computing device 100. In examples described herein, computing device 100 may be an image capturing device and/or a video capturing device. Computing device 100 is shown in the form factor of a mobile phone. However, computing device 100 may be alternatively implemented as a laptop computer, a tablet computer, and/or a wearable computing device, among other possibilities. Computing device 100 may include various elements, such as body 102, display 106, and buttons 108 and 110. Computing device 100 may further include one or more cameras, such as front-facing camera 104 and at least one rear-facing camera 112. In examples with multiple rear-facing cameras such as illustrated in FIG. 1, each of the rear-facing cameras may have a different field of view. For example, the rear facing cameras may include a wide angle camera, a main camera, and a telephoto camera. The wide angle camera may capture a larger portion of the environment compared to the main camera and the telephoto camera, and the telephoto camera may capture more detailed images of a smaller portion of the environment compared to the main camera and the wide angle camera.

Front-facing camera 104 may be positioned on a side of body 102 typically facing a user while in operation (e.g., on the same side as display 106). Rear-facing camera 112 may be positioned on a side of body 102 opposite front-facing camera 104. Referring to the cameras as front and rear facing is arbitrary, and computing device 100 may include multiple cameras positioned on various sides of body 102.

Display 106 could represent a cathode ray tube (CRT) display, a light emitting diode (LED) display, a liquid crystal (LCD) display, a plasma display, an organic light emitting diode (OLED) display, or any other type of display known in the art. In some examples, display 106 may display a digital representation of the current image being captured by front-facing camera 104 and/or rear-facing camera 112, an image that could be captured by one or more of these cameras, an image that was recently captured by one or more of these cameras, and/or a modified version of one or more of these images. Thus, display 106 may serve as a viewfinder for the cameras. Display 106 may also support touchscreen functions that may be able to adjust the settings and/or configuration of one or more aspects of computing device 100.

Front-facing camera 104 may include an image sensor and associated optical elements such as lenses. Front-facing camera 104 may offer zoom capabilities or could have a fixed focal length. In other examples, interchangeable lenses could be used with front-facing camera 104. Front-facing camera 104 may have a variable mechanical aperture and a mechanical and/or electronic shutter. Front-facing camera 104 also could be configured to capture still images, video images, or both. Further, front-facing camera 104 could represent, for example, a monoscopic, stereoscopic, or multiscopic camera. Rear-facing camera 112 may be similarly or differently arranged. Additionally, one or more of front-facing camera 104 and/or rear-facing camera 112 may be an array of one or more cameras.

One or more of front-facing camera 104 and/or rear-facing camera 112 may include or be associated with an illumination component that provides a light field to illuminate a target object. For instance, an illumination component could provide flash or constant illumination of the target object. An illumination component could also be configured to provide a light field that includes one or more of structured light, polarized light, and light with specific spectral content. Other types of light fields known and used to recover three-dimensional (3D) models from an object are possible within the context of the examples herein.

Computing device 100 may also include an ambient light sensor that may continuously or from time to time determine the ambient brightness of a scene that cameras 104 and/or 112 can capture. In some implementations, the ambient light sensor can be used to adjust the display brightness of display 106. Additionally, the ambient light sensor may be used to determine an exposure length of one or more of cameras 104 or 112, or to help in this determination.

Computing device 100 could be configured to use display 106 and front-facing camera 104 and/or rear-facing camera 112 to capture images of a target object. The captured images could be a plurality of still images or a video stream. The image capture could be triggered by activating button 108, pressing a softkey on display 106, or by some other mechanism. Depending upon the implementation, the images could be captured automatically at a specific time interval, for example, upon pressing button 108, upon appropriate lighting conditions of the target object, upon moving computing device 100 a predetermined distance, or according to a predetermined capture schedule.

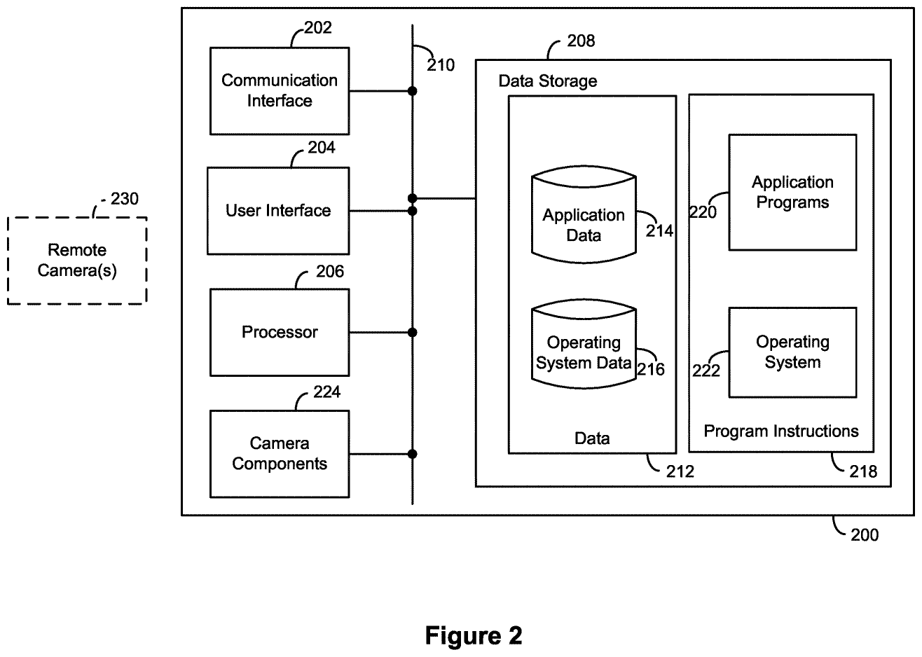

FIG. 2 is a simplified block diagram showing some of the components of an example computing system 200, such as an image capturing device and/or a video capturing device. By way of example and without limitation, computing system 200 may be a cellular mobile telephone (e.g., a smartphone), a computer (such as a desktop, notebook, tablet, server, or handheld computer), a home automation component, a digital video recorder (DVR), a digital television, a remote control, a wearable computing device, a gaming console, a robotic device, a vehicle, or some other type of device. Computing system 200 may represent, for example, aspects of computing device 100.

As shown in FIG. 2, computing system 200 may include communication interface 202, user interface 204, processor 206, data storage 208, and camera components 224, all of which may be communicatively linked together by a system bus, network, or other connection mechanism 210. Computing system 200 may be equipped with at least some image capture and/or image processing capabilities. It should be understood that computing system 200 may represent a physical image processing system, a particular physical hardware platform on which an image sensing and/or processing application operates in software, or other combinations of hardware and software that are configured to carry out image capture and/or processing functions.

Communication interface 202 may allow computing system 200 to communicate, using analog or digital modulation, with other devices, access networks, and/or transport networks. Thus, communication interface 202 may facilitate circuit-switched and/or packet-switched communication, such as plain old telephone service (POTS) communication and/or Internet protocol (IP) or other packetized communication. For instance, communication interface 202 may include a chipset and antenna arranged for wireless communication with a radio access network or an access point. Also, communication interface 202 may take the form of or include a wireline interface, such as an Ethernet, Universal Serial Bus (USB), or High-Definition Multimedia Interface (HDMI) port, among other possibilities. Communication interface 202 may also take the form of or include a wireless interface, such as a Wi-Fi, BLUETOOTH®, global positioning system (GPS), or wide-area wireless interface (e.g., WiMAX or 3GPP Long-Term Evolution (LTE)), among other possibilities. However, other forms of physical layer interfaces and other types of standard or proprietary communication protocols may be used over communication interface 202. Furthermore, communication interface 202 may comprise multiple physical communication interfaces (e.g., a Wi-Fi interface, a BLUETOOTH® interface, and a wide-area wireless interface).

User interface 204 may function to allow computing system 200 to interact with a human or non-human user, such as to receive input from a user and to provide output to the user. Thus, user interface 204 may include input components such as a keypad, keyboard, touch-sensitive panel, computer mouse, trackball, joystick, microphone, and so on. User interface 204 may also include one or more output components such as a display screen, which, for example, may be combined with a touch-sensitive panel. The display screen may be based on CRT, LCD, LED, and/or OLED technologies, or other technologies now known or later developed. User interface 204 may also be configured to generate audible output(s), via a speaker, speaker jack, audio output port, audio output device, earphones, and/or other similar devices. User interface 204 may also be configured to receive and/or capture audible utterance(s), noise(s), and/or signal(s) by way of a microphone and/or other similar devices.

In some examples, user interface 204 may include a display that serves as a viewfinder for still camera and/or video camera functions supported by computing system 200. Additionally, user interface 204 may include one or more buttons, switches, knobs, and/or dials that facilitate the configuration and focusing of a camera function and the capturing of images. It may be possible that some or all of these buttons, switches, knobs, and/or dials are implemented by way of a touch-sensitive panel.

Processor 206 may comprise one or more general purpose processors—e.g., microprocessors—and/or one or more special purpose processors—e.g., digital signal processors (DSPs), graphics processing units (GPUs), floating point units (FPUs), network processors, or application-specific integrated circuits (ASICs). In some instances, special purpose processors may be capable of image processing, image alignment, and merging images, among other possibilities. Data storage 208 may include one or more volatile and/or non-volatile storage components, such as magnetic, optical, flash, or organic storage, and may be integrated in whole or in part with processor 206. Data storage 208 may include removable and/or non-removable components.

Processor 206 may be capable of executing program instructions 218 (e.g., compiled or non-compiled program logic and/or machine code) stored in data storage 208 to carry out the various functions described herein. Therefore, data storage 208 may include a non-transitory computer-readable medium, having stored thereon program instructions that, upon execution by computing system 200, cause computing system 200 to carry out any of the methods, processes, or operations disclosed in this specification and/or the accompanying drawings. The execution of program instructions 218 by processor 206 may result in processor 206 using data 212.

By way of example, program instructions 218 may include an operating system 222 (e.g., an operating system kernel, device driver(s), and/or other modules) and one or more application programs 220 (e.g., camera functions, address book, email, web browsing, social networking, audio-to-text functions, text translation functions, and/or gaming applications) installed on computing system 200. Similarly, data 212 may include operating system data 216 and application data 214. Operating system data 216 may be accessible primarily to operating system 222, and application data 214 may be accessible primarily to one or more of application programs 220. Application data 214 may be arranged in a file system that is visible to or hidden from a user of computing system 200.

Application programs 220 may communicate with operating system 222 through one or more application programming interfaces (APIs). These APIs may facilitate, for instance, application programs 220 reading and/or writing application data 214, transmitting or receiving information via communication interface 202, receiving and/or displaying information on user interface 204, and so on.

In some cases, application programs 220 may be referred to as “apps” for short. Additionally, application programs 220 may be downloadable to computing system 200 through one or more online application stores or application markets. However, application programs can also be installed on computing system 200 in other ways, such as via a web browser or through a physical interface (e.g., a USB port) on computing system 200.

Camera components 224 may include, but are not limited to, an aperture, shutter, recording surface (e.g., photographic film and/or an image sensor), lens, shutter button, infrared projectors, and/or visible-light projectors. Camera components 224 may include components configured for capturing of images in the visible-light spectrum (e.g., electromagnetic radiation having a wavelength of 380-700 nanometers) and/or components configured for capturing of images in the infrared light spectrum (e.g., electromagnetic radiation having a wavelength of 701 nanometers-1 millimeter), among other possibilities. Camera components 224 may be controlled at least in part by software executed by processor 206.

In further examples, one or more remote cameras 230 may be controlled by computing system 200. For instance, computing system 200 may transmit control signals to the one or more remote cameras 230 through a wireless or wired connection. Such signals may be transmitted as part of an ambient computing environment. In such examples, inputs received at the computing system 200 (for instance, physical movements of a wearable device) may be mapped to movements or other functions of the one or more remote cameras 230. Images captured by the one or more remote cameras 230 may be transmitted to the computing system 200 for further processing. Such images may be treated as images captured by cameras physically located on the computing system 200.

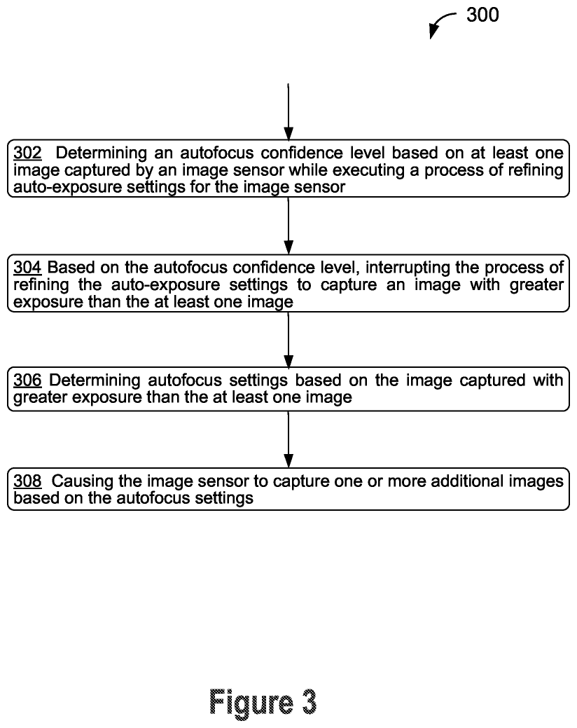

FIG. 3 is a flow chart of method 300, in accordance with example embodiments. Method 300 may be executed by one or more computing systems (e.g., computing system 200 of FIG. 2) and/or one or more processors (e.g., processor 206 of FIG. 2). Method 300 may be carried out on a computing system, such as computing system 100 of FIG. 1.

At block 302, method 300 includes determining an autofocus confidence level based on at least one image captured by an image sensor while executing a process of refining auto-exposure settings for the image sensor. A computing system may continuously execute the process for determining the auto-exposure settings, Auto-exposure settings may include one or more of an aperture (lens width), shutter speed (how quickly the shutter opens and closes), and/or International Standards Organization (ISO) sensitivity (the image sensor's sensitivity to light). For instance, the computing system may capture an image or otherwise determine an image, and based on the image, the computing system may determine the auto-exposure settings. The computing system may update the auto-exposure settings based on the determined auto-exposure settings. The computing system may take a further image with the updated auto-exposure settings and determine further updated auto-exposure settings based on the further image. The computing system may repeat this process to continuously refine the auto-exposure settings, and as such, the process of refining the auto-exposure settings may be a closed loop process.

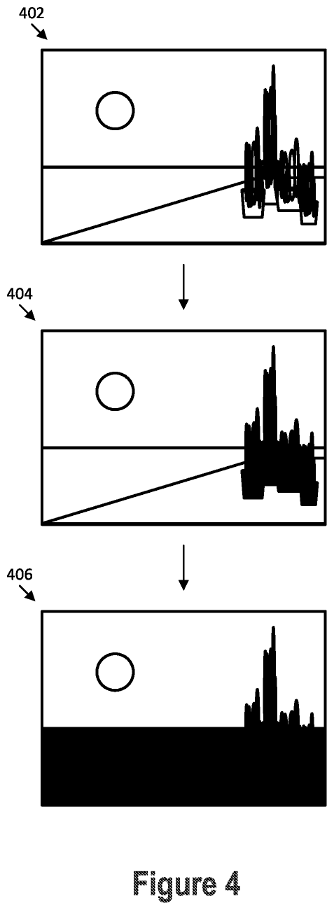

FIG. 4 depicts images 402, 404, and 406, in accordance with example embodiments. The computing system may capture 402, 404, and 406 during the auto-exposure process described above, such that updated auto-exposure settings are determined after each subsequent image. For instance, the computing system may determine updated auto-exposure settings after image 402, which may be used to capture image 404. The computing system may determine further updated auto-exposure settings after image 404, which may be used to capture image 406.

In some examples, the image may be a high dynamic range image. As mentioned above, a high dynamic range image may be an image that includes very bright areas relative to the rest of the image and/or very dark areas relative to the rest of the image. As shown in images 402, 404, and 406, high dynamic range images may include a sun or other source of light illuminating objects from behind. In some examples, high dynamic range images may include a face in front of a window, a window in a room, and buildings or rocks in front of the sun, among other examples.

The computing system may determine auto-exposure settings that underexpose the scene, perhaps in response to a determination that the image is a high dynamic range image. An underexposed image may be an image captured with a lighting level that results in a large portion of an image being dark (e.g., a main portion of an image) and/or otherwise darker than normally perceived. Because high dynamic range images may include areas that are very bright, the computing system may be able to extract more information when the image is underexposed, and the computing system may be able to post-process the underexposed image to include more details. In contrast, if the computing system captures an image using exposure settings that overexpose the image, the computing system may be unable to post-process the overexposed image to include certain details. For instance, the computing system may have captured image 404 using exposure settings that intentionally underexpose the image, and as such, image 404 may include a sun, a sky, the ground, and some plants. If the computing system captured image 404 using exposure settings that do not underexpose the image, the sun, the sky, and the ground may be washed out such that the sun, the sky, and the ground appear as one area.

In some examples, the computing system may determine auto-exposure settings based on sensor data collected by various sensors, such as phase detection sensors, light detection sensors, and/or image sensors. For example, the computing system may receive phase detection data from phase detection sensors, which may collect data having a left and a right view. The computing system may determine the exposure settings based on the phase detection data. Additionally and/or alternatively, the computing system may collect lighting data from one or more light detection sensors, and the computing system may determine auto-exposure settings based on the collected lighting data. Further additionally and/or alternatively, the computing system may determine auto-exposure settings based on images 402, 404, and/or 406. The computing system may analyze an image, e.g., image 402, to determine one or more lighting metrics. Based on the determined lighting metrics, the computing system may determine the auto-exposure settings. The auto-exposure settings may also be determined based on data collected by other sensors, e.g., depth sensors, among other examples.

The computing system may display images 402, 404, and 406 to a user in sequence as the computing system adjusts the auto-exposure settings, perhaps as an image preview process or an image capturing process. In some examples, the computing system may process images 402, 404, and/or 406 before displaying the images to the user. For instance, the computing system may increase the brightness and/or the saturation of one or more portions of the image (e.g., the areas that are underexposed) or otherwise extract details from images 402, 404, and/or 406, before displaying the images to the user.

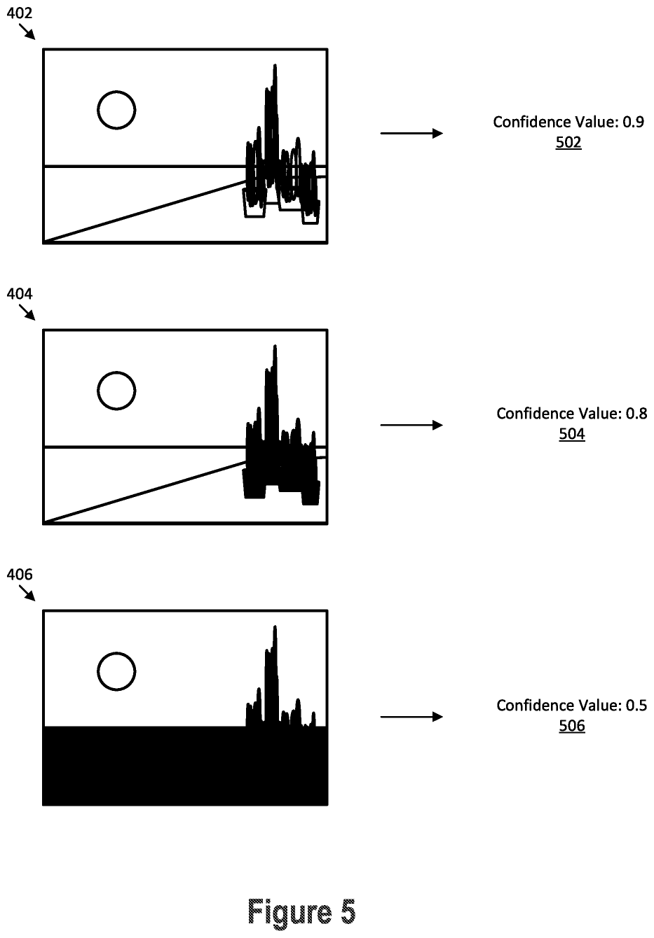

The computing system may determine an autofocus confidence level based on images captured with the respective auto-exposure settings. For example, FIG. 5 depicts images 402, 404, and 406 with associated confidence values 502, 504, and 506, respectively, in accordance with example embodiments. The computing system may determine the confidence values based on one or more metrics, such as a signal to noise ratio of an image captured by the image sensor, among other metrics.

Determining confidence values 502, 504, and 506 from images 402, 404, and 406 may be part of an autofocus process, which the computing system may run in parallel with an auto-exposure process. For instance, the computing system may capture image 402 and adjust the auto-exposure settings based on the settings with which image 402 was captured. As part of an autofocus process, the computing system may use image 402 or other sensor data based on the settings with which image 402 was captured to determine a signal to noise ratio or otherwise determine confidence value 502 to be 0.9. The computing system may compare confidence value 502 of 0.9 to a threshold confidence value (e.g., a threshold signal to noise ratio), and the computing system may determine that confidence value 502 is above the threshold confidence value.

The computing system may continue to capture an image with the updated exposure settings to capture image 404, then determine further updated exposure settings based on image 404 or the settings with which image 404 was captured. Based on these further updated settings, the computing system may capture image 406. For each subsequent image, the computing system may run in parallel the autofocus method that determines the confidence values for each image.

After capturing image 406 and determining confidence value 506 for image 406, the computing system may determine that confidence value 506 for image 406 is not above the threshold confidence value, perhaps indicating that an accurate autofocus cannot be determined based on sensor data collected with the auto-exposure settings used to capture image 406. Based on this determination, the computing system may take one or more actions, which will be discussed further below. The computing system may trigger these one or more actions based on other determinations and/or metrics as well, for instance, a confidence value of the image in conjunction with other autofocus accuracy metrics determined based on sensor data received under the auto-exposure settings with which the image was captured.

Referring back to method 300, at block 304, method 300 includes, based on the autofocus confidence level, interrupting the process of refining the auto-exposure settings to capture an image with greater exposure than the at least one image. In some examples, capturing an image with greater exposure than the at least one image may involve scheduling capture of an image with greater exposure than the at least one image, perhaps by adjusting the exposure time. In particular, the image with greater exposure may be captured with greater exposure time than the image with lesser exposure.

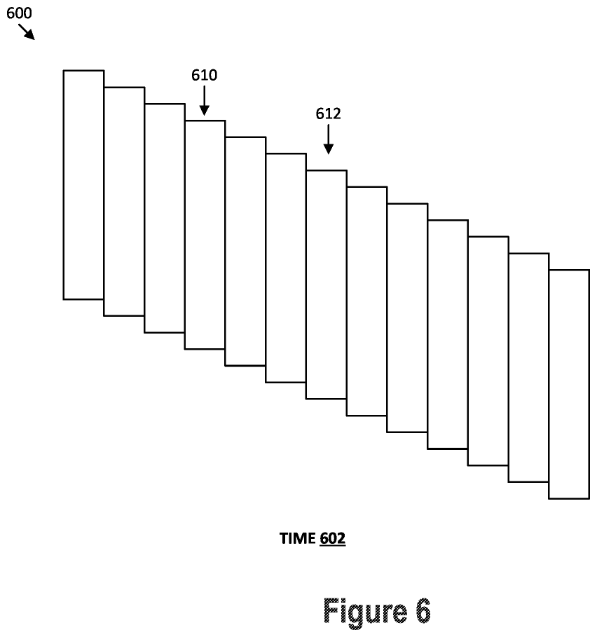

FIG. 6 depicts capturing a sequence of images, in accordance with example embodiments. FIG. 6 may include a sequence of images 600 captured over time 602, such that each block depicts capture of an image. At block 610, the computing system may capture an image and determine that the auto-exposure settings used to capture the image (e.g., image 406 of FIGS. 4 and 5) are inadequate to determine accurate autofocus settings. The computing system may then schedule capture of an image with greater exposure than the image captured at block 610 at a particular time in the future. For example, the computing system may schedule capture of an image at block 612 at two frames in the future.

In some examples, scheduling capture of the image with greater exposure is based on a frame rate of the display, the exposure time of images captured during the auto-exposure process, the exposure time needed for the image captured for autofocus, among other factors. For instance, if the display has a frame rate of 30 frames per second, and the stream of images has an exposure time of 1/2000 seconds, the computing system may schedule capture of an image for autofocus with an exposure time of 1/1000 seconds. Due to the frame rate at which the computing system displays images, the image for autofocus may be scheduled to be captured directly between two images captured for display, and the two images captured for display may be displayed normally (e.g., for a duration of 1/30 seconds as set based on the frame rate of the display).

The computing system may also schedule the image with greater exposure for capture so that the computing system may adequately compensate for any delay caused by the capture of the image with greater exposure. For example, the computing system may determine that the display refreshes at a frame rate of 30 frames per second. The computing system may capture a stream of images for display at approximately 1/30 seconds, and the computing system may determine that an exposure time of 1/15 seconds may be used to determine an image or other sensor data to be used in the determination of autofocus. Therefore, the computing system may schedule capture of the image with the exposure time of 1/15 seconds based on the capture of the image being at least two frames in advance, so that the computing system may distribute the next two frames to be displayed for 1/15 seconds each to compensate for the exposure time of 1/15 seconds of the image captured for autofocus.

Other factors (e.g., software delays, hardware delays, etc.) may also be factored into the determination of a time in the future at which to capture the image.

Capturing the image for autofocus may interrupt the auto-exposure process. In particular, the computing system may pause or otherwise stop execution of the process for refining auto-exposure settings for the image sensor, and the computing system may instead capture the image for autofocus. In some examples, the computing system may collect data using the same sensors for the auto-exposure process as the autofocus process, and the computing system may use the collected data for autofocus rather than auto-exposure. In further examples, the computing system may set the exposure settings to result in a more exposed image during the autofocus process, before resetting the exposure settings to be the same as before the autofocus process.

In some examples, an auto-exposure module of the computing device may carry out refining the auto-exposure settings, and interrupting the process of refining the auto-exposure settings may involve the computing system transmitting a request to the auto-exposure module. The request may include instructions to reconfigure the exposure settings to increase the exposure of the next image captured by the image sensor.

As depicted in sequence of images 600, determining the auto-exposure settings may be a closed loop process, whereas determining the autofocus settings may be an open loop process that is not iterative. In particular, the computing system may be using each of the images in sequence of images 600 except at block 612 or data collected using the settings of each of the images in sequence of images 600 except at block 612 to determine and update the auto-exposure settings at each block/image. The computing system may loop this process of capturing an image, displaying the image, determining updated auto-exposure settings based on the image or other sensor data captured with the auto-exposure settings of the image, and updating the auto-exposure settings with the updated auto-exposure settings. The computing system may run this loop indefinitely or until the auto-exposure settings converge on a particular auto-exposure setting. In contrast, the autofocus process may involve capturing one image (e.g., an image at block 612), and the computing system may use the image to determine autofocus settings. Thus, determining the autofocus settings may not be iterative to the extent that the autofocus settings are not determined and updated at each subsequent image. Rather, the autofocus settings are determined based on a single image scheduled to be captured in advance. If the autofocus setting is insufficient, the computing system may schedule capture of another image, and the computing system may use the image to further determine the autofocus settings. By decoupling the auto-exposure process and the autofocus process, the process described herein may be able to avoid the tradeoff between high dynamic range and focus accuracy in challenging light conditions (e.g., backlit lighting conditions).

Referring back to method 300, at block 306, method 300 includes determining autofocus settings based on the image captured with greater exposure than the at least one image. The autofocus settings may include a focal length and/or focal distance. The autofocus settings may be determined based on data from various sensors, including, e.g., phase detection sensors and/or cameras. An image captured with greater exposure than another image may be brighter than the other image.

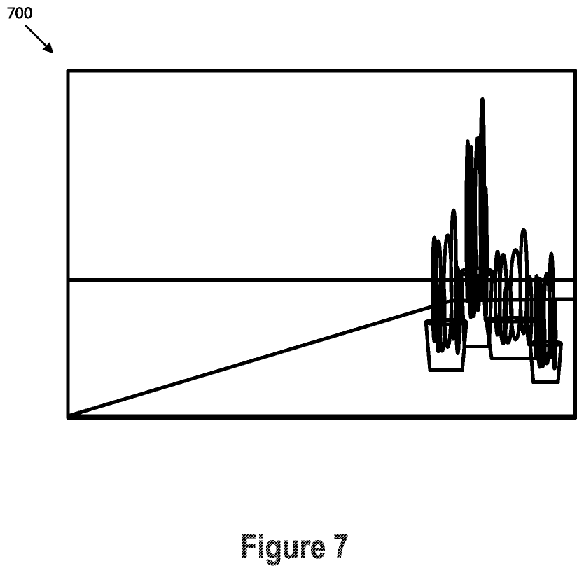

FIG. 7 depicts image 700 captured for autofocus, in accordance with example embodiments. Image 700 may be of the same scene as images 402, 404, and 406 of FIGS. 4-5. In comparison to images 402, 404, and 406, however, image 700 may have greater exposure, which may help the computing system make a more accurate autofocus determination. As depicted by image 700, the greater exposure settings used to capture image 700 may have washed out particular details in the image (e.g., the sun). Based on image 700 and/or other sensor data captured with the greater exposure settings, the computing system may determine an autofocused image.

In particular, the computing system may be able to more accurately determine autofocus settings using images captured with greater exposure, as the images may include less noise. Further, areas in the image that were dark may become brighter, which may allow the computing system to determine on which area of the darker areas to focus. In post processing, the computing system may be able to extract details from the darker areas due to the image being underexposed and the image being focused at a particular portion in the darker area.

Referring back to method 300, at block 308, method 300 includes causing the image sensor to capture one or more additional images based on the autofocus settings. After configuring the image sensor based on the autofocus settings, the computing system may proceed with carrying out the process for refining the auto-exposure settings or otherwise causing capture of data based on the updated autofocus settings.

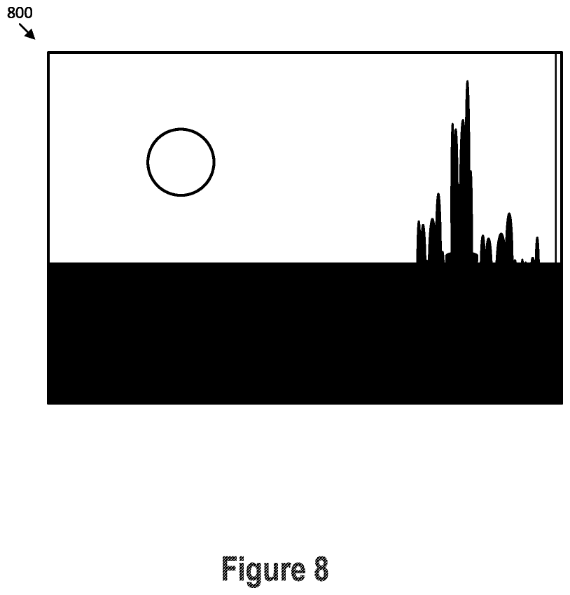

FIG. 8 depicts image 800 captured with updated autofocus settings, in accordance with example embodiments. The computing system may revert back to previously determined auto-exposure settings, which may help maximize dynamic range in the image and allow the computing system to capture an image with the maximum amount of detail. Image 900, as captured with the updated autofocus settings and the previously determined auto-exposure settings, may be displayed on a display, perhaps after post processing. In contrast, the images used to determine autofocus (e.g., image 700 of FIG. 7) may be excluded from display.

In some examples, the auto-exposure process and the autofocus process may be executed for a camera or image sensor system remote from the computing system. The camera or image sensor system may send collected data to the computing system, and the computing system may determine updated auto-exposure settings, which the computing system may then send to the camera or image sensor system. The computing system may determine that the confidence level is not above a threshold confidence level, and the computing system may schedule capture of an image for autofocus. The computing system may send the exposure settings to the camera or image sensor system to capture the image for autofocus, and after the capture of the image for autofocus, the computing system may determine the updated autofocus settings. The computing system may send the updated autofocus images to the remote camera or image sensor system and send an indication to revert the exposure settings to the auto-exposure settings. The computing system may include a display, which may display the images used for auto-exposure and/or processed images of the images used for auto-exposure,

In some examples, determining the autofocus confidence level comprises determining a signal to noise ratio of the at least one image captured by the image sensor while executing the process of refining the auto-exposure settings.

In some examples, determining the autofocus confidence level further comprises determining that the signal to noise ratio is less than a threshold signal to noise ratio, where interrupting the process of refining the auto-exposure settings is triggered based on the determination that the signal to noise ratio is less than the threshold signal to noise ratio.

In some examples, method 300 further includes causing display of the at least one image captured by the image sensor while executing the process of refining the auto-exposure settings for the image sensor, and excluding display of the image captured with greater exposure than the at least one image.

In some examples, method 300 further includes causing display of the at least one image captured by the image sensor while executing the process of interrupting the process of refining the auto-exposure settings to capture the image with greater exposure than the at least one image.

In some examples, interrupting the process of refining the auto-exposure settings to capture the image with greater exposure than the at least one image comprises (i) scheduling capture of the image at a particular time in the future based on a frame rate of display of the at least one image captured by the image sensor, (ii) at the particular time, stopping execution of the process of refining auto-exposure settings for the image sensor, (iii) adjusting the auto-exposure settings of the image sensor, and (iv) capturing the image with greater exposure than the at least one image.

In some examples, method 300 includes after configuring the image sensor based on the autofocus settings, further executing the process of refining auto-exposure settings for the image sensor.

In some examples, interrupting the process of refining the auto-exposure settings to capture the image with greater exposure than the at least one image is based on determining that the at least one image is a high dynamic range image.

In some examples, method 300 includes causing capture of the at least one image based on a first set of autofocus settings, and, after capturing the image with greater exposure than the at least one image, causing capture of the image based on a second set of autofocus settings different from the first set of autofocus settings.

In some examples, refining the auto-exposure settings is based on a plurality of images, where determining the autofocus settings based on the image involves a single image.

In some examples, executing the process of refining auto-exposure settings for the image sensor is based on sensor data collected by one or more phase detection sensors.

In some examples, executing the process of refining auto-exposure settings for the image sensor is based on depth sensor data.

In some examples, determining the autofocus settings is not iterative.

In some examples, interrupting the process of refining the auto-exposure settings to capture an image with greater exposure than the at least one image comprises configuring exposure settings to include an exposure time of greater length than an exposure time used to capture the at least one image.

In some examples, refining the auto-exposure settings is carried out by an auto-exposure module, where interrupting the process of refining the auto-exposure settings to capture the image with greater exposure than the at least one image comprises transmitting a request to the auto-exposure module to reconfigure exposure settings.

In some examples, determining the autofocus settings based on the image is an open loop process.

In some examples, executing the process of refining auto-exposure settings for the image sensor is a closed loop process.

In some examples, a computing system includes a control system configured to perform operations comprising those of method 300 and those described above.

In some examples, the control system is further configured to determine the autofocus settings based on sensor data collected by the one or more phase detection sensors.

In some examples, a non-transitory computer readable medium storing program instructions executable by one or more processors to cause the one or more processors to perform operations comprising those of method 300 and those described above.

### III. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for the purpose of illustration and are not intended to be limiting, with the true scope being indicated by the following claims.

We claim:

1. A method comprising:
determining an autofocus confidence level based on at least one image captured by an image sensor while executing a process of refining auto-exposure settings for the image sensor;
based on the autofocus confidence level, interrupting the process of refining the auto-exposure settings for the image sensor to capture an image with greater exposure than the at least one image;
determining autofocus settings based on the image captured with greater exposure than the at least one image; and
causing the image sensor to capture one or more additional images based on the autofocus settings.

2. The method of claim 1, wherein determining the autofocus confidence level comprises:
determining a signal to noise ratio of the at least one image captured by the image sensor while executing the process of refining the auto-exposure settings for the image sensor.

3. The method of claim 2, wherein determining the autofocus confidence level further comprises determining that the signal to noise ratio is less than a threshold signal to noise ratio.

4. The method of claim 1, further comprising:
causing display of the at least one image captured by the image sensor while executing the process of refining the auto-exposure settings for the image sensor; and
excluding display of the image captured with greater exposure than the at least one image.

5. The method of claim 1, further comprising causing display of the at least one image captured by the image sensor while interrupting the process of refining the auto-exposure settings for the image sensor to capture the image with greater exposure than the at least one image.

6. The method of claim 1, wherein interrupting the process of refining the auto-exposure settings for the image sensor to capture the image with greater exposure than the at least one image comprises:
scheduling capture of the image with greater exposure than the at least one image at a particular time in the future based on a frame rate of display of the at least one image captured by the image sensor;
at the particular time, stopping execution of the process of refining the auto-exposure settings for the image sensor;
adjusting the auto-exposure settings of the image sensor; and
capturing the image with greater exposure than the at least one image.

7. The method of claim 1, further comprising:
after determining the autofocus settings, further executing the process of refining the auto-exposure settings for the image sensor such that the one or more additional images are captured with different auto-exposure settings.

8. The method of claim 1, wherein interrupting the process of refining the auto-exposure settings for the image sensor to capture the image with greater exposure than the at least one image is based on determining that the at least one image represents a scene with a high dynamic range.

9. The method of claim 1, further comprising:
causing capture of the at least one image based on a first set of autofocus settings, wherein the determined set of autofocus settings comprises a second set of autofocus settings different from the first set of autofocus settings.

10. The method of claim 1, wherein refining the auto-exposure settings for the image sensor is based on a plurality of images, wherein determining the autofocus settings based on the image captured with greater exposure than the at least one image involves a single image.

11. The method of claim 1, wherein executing the process of refining the auto-exposure settings for the image sensor is based on sensor data collected by one or more phase detection sensors.

12. The method of claim 1, wherein executing the process of refining the auto-exposure settings for the image sensor is based on depth sensor data.

13. The method of claim 1, wherein determining the autofocus settings is not iterative.

14. The method of claim 1, wherein interrupting the process of refining the auto-exposure settings for the image sensor to capture the image with greater exposure than the at least one image comprises configuring exposure settings to include an exposure time of greater length than an exposure time used to capture the at least one image.

15. The method of claim 1, wherein refining the auto-exposure settings for the image sensor is carried out by an auto-exposure module, wherein interrupting the process of refining the auto-exposure settings for the image sensor to capture the image with greater exposure than the at least one image comprises transmitting a request to the auto-exposure module to reconfigure exposure settings.

16. The method of claim 1, wherein determining the autofocus settings based on the image captured with greater exposure than the at least one image is an open loop process.

17. The method of claim 1, wherein refining the auto-exposure settings for the image sensor is a closed loop process.

18. A computing system comprising:
a control system configured to:
determine an autofocus confidence level based on at least one image captured by an image sensor while executing a process of refining auto-exposure settings for the image sensor;
based on the autofocus confidence level, interrupt the process of refining the auto-exposure settings for the image sensor to capture an image with greater exposure than the at least one image;
determine autofocus settings based on the image captured with greater exposure than the at least one image; and
cause the image sensor to capture one or more additional images based on the autofocus settings.

19. The computing system of claim 18, wherein the control system is further configured to determine the autofocus settings based on sensor data collected by one or more phase detection sensors.

20. A non-transitory computer readable medium storing program instructions executable by one or more processors to cause the one or more processors to perform operations comprising:
determining an autofocus confidence level based on at least one image captured by an image sensor while executing a process of refining auto-exposure settings for the image sensor;
based on the autofocus confidence level, interrupting the process of refining the auto-exposure settings for the image sensor to capture an image with greater exposure than the at least one image;
determining autofocus settings based on the image captured with greater exposure than the at least one image; and
causing the image sensor to capture one or more additional images based on the autofocus settings.
